(19) United States
(12) Patent Application Publication
(10) Pub. No.: US 2014/0208044 A1
(43) Pub. Date: Jul. 24, 2014

(54) SEMICONDUCTOR DEVICE AND METHOD OF OPERATING THE SAME

(71) Applicant: SK HYNIX INC., Gyeonggi-do (KR)

(72) Inventor: Eui Jin KIM, Gyeonggi-do (KR)

(73) Assignee: SK HYNIX INC., Gyeonggi-do (KR)

(21) Appl. No.: 13/844,914

(22) Filed: Mar. 16, 2013

(30) Foreign Application Priority Data
Jan. 22, 2013 (KR) 10-2013-0006893

(51) Int. Cl. G06F 12/00

(52) U.S. Cl. CPC G06F 12/00
USPC 711/154

(57) ABSTRACT

A method of operating a semiconductor device may comprise storing data in memory cells coupled to first word lines of memory blocks including the first word lines and second word lines located respectively between the first word lines, detecting a memory block, where data stored in the memory cells of the first word lines is invalidated, from the memory blocks, and storing data in memory cells coupled to the second word lines of the detected memory block.

### CROSS-REFERENCE TO RELATED APPLICATION

This application claims priority from Korean Patent Application No. 10-2013-0006893, filed on Jan. 22, 2013, the contents of which are incorporated herein by reference in its entirety.

### BACKGROUND

1. Field

Exemplary embodiments of the present invention relate to a semiconductor device and a method of operating the same, more particularly, to a semiconductor device capable of inputting and outputting data and a method of operating the same.

2. Discussion of Related Art

A semiconductor device capable of inputting and outputting data includes memory blocks. Each of the memory blocks includes memory cells coupled to word lines. In each of the memory blocks, data is stored in the memory cells in sequential order of word lines coupled thereto.

In a non-volatile memory device such as an NAND flash memory, data is stored in memory cells through a program operation, which affects threshold voltage of the memory cells.

To increase storage capacity in limited size, attempt to increase integrity of the memory device and store data of two bits or more in one memory cell has been made. Interval between word lines becomes narrower according as the integrity becomes higher, which incurs interference between adjacent word lines. For example, threshold voltage of the memory cell having data increases due to capacitance coupling effect caused by a program operation of adjacent word line.

The interference reduces sensing margin for reading data and changes the stored data in the memory cell. As a result, electrical characteristics and reliability of the operation of the memory device may deteriorate.

### SUMMARY OF THE INVENTION

Exemplary embodiments of the present invention are directed to provide a semiconductor device with enhanced electrical characteristics and reliability of its operation and a method of operating the same.

In an embodiment, a method of operating a semiconductor device may include storing data in memory cells coupled to first word lines of memory blocks including the first word lines and second word lines located respectively between the first word lines; detecting a memory block, where data stored in the memory cells of the first word lines is invalidated, from the memory blocks; and storing data in memory cells coupled to the second word lines of the detected memory block.

In an embodiment, a semiconductor device may include memory blocks, each memory block including first word lines and second word lines located respectively between the first word lines; and a peripheral circuit configured to store data in memory cells coupled to the first word lines of the memory blocks, and store data in memory cells coupled to the second word lines of detected memory block in the event that a memory block, where every data stored in the memory cells of the first word lines is invalidated, is detected from the memory blocks.

In an embodiment, a semiconductor device may include a memory device configured to include memory blocks, each memory block include first word lines and second word lines located respectively between the first word lines; and a memory controller configured to store data in memory cells coupled to the first word lines of a memory block selected from the memory blocks, and change a physical address to a logical address and output the logical address, to store data in memory cells coupled to the second word lines in the event that the stored data are invalidated.

According to exemplary embodiment of the present invention, electrical characteristics and reliability of operation of a semiconductor device may be enhanced.

### BRIEF DESCRIPTION OF THE DRAWINGS

The above and other features and advantages of the present invention will become readily apparent by reference to the following detailed description when considered in conjunction with the accompanying drawings wherein:

FIG. 1 illustrates semiconductor device according to one embodiment of the present invention,

FIG. 2 illustrates a flowchart of operation of a semiconductor device according to one embodiment of the present invention,

FIG. 3 illustrates a flowchart of detailed process of step S210 in FIG. 2,

FIG. 4 illustrates a memory device showing an operation of step S210 in FIG. 2 according to one embodiment of the present invention,

FIG. 5 illustrates memory devices showing an operation of step S230 in FIG. 2 according to one embodiment of the present invention,

FIG. 6 illustrates memory devices showing an operation of step S260 in FIG. 2 according to one embodiment of the present invention,

FIGS. 7 and 8 illustrate memory devices showing an operation of step S240 in FIG. 2 according to one embodiment of the present invention, and

FIG. 9 illustrates a flowchart of operation of the semiconductor device according to another embodiment of the present invention.

### DETAILED DESCRIPTION

Various embodiments of the present invention will be explained below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, reference numerals correspond directly to the like parts in the various figures and embodiments of the present invention.

It is also noted that in this specification, “connected/coupled” refers to one component not only directly coupling another component but also indirectly coupling another component through an intermediate component. In addition, a singular form may include a plural form as long as it is not specifically mentioned in a sentence.

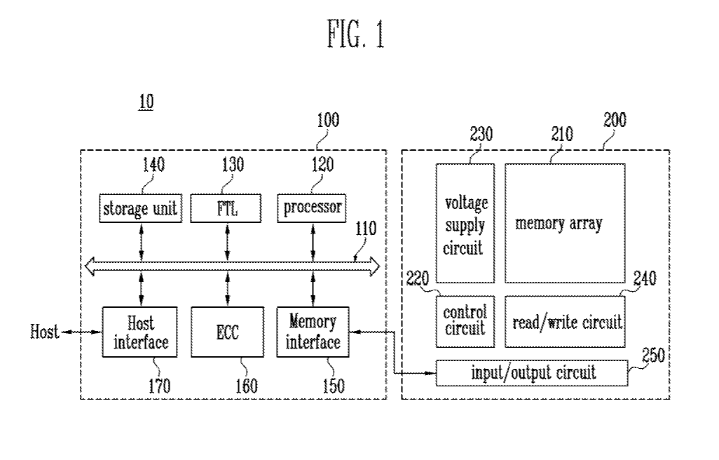

FIG. 1 illustrates semiconductor device according to one embodiment of the present invention.

As illustrated in FIG. 1, a semiconductor device 10 may include a memory controller 100 and a memory device 200. The memory controller 100 is coupled to a host Host and the memory device 200. The memory controller 100 accesses to the memory device 200 in response to request of the host Host. For example, the memory controller 100 controls a read operation, a program operation and an erase operation of the memory device 200. The memory controller 100 provides an interface between the memory device 200 and the host Host. The memory controller 100 drives a firmware for controlling the memory device 200. The memory device 200 may include a flash memory device.

The memory controller 100 may include an internal bus 110, a processor 120, a storage unit 140, a memory interface 150, an error correction block 160 and a host interface 170. The internal bus 110 provides a channel between elements in the memory controller 100. For example, the internal bus 110 may be a common channel for transmitting a command and data. For another example, the internal bus 110 may include a command channel for transmitting a command and a data channel for transmitting data.

The processor 120 controls operation of the memory controller 100. The processor 120 may execute software and a firmware driven by the memory controller 100. The storage unit 140 may be used as an operation memory of the processor 120. The storage unit 140 may be used as a buffer memory between the memory device 200 and the host Host. The storage unit 140 may be used as a cache memory between the memory device 200 and the host Host. For example, the storage unit 140 may include at least one of various random access memories, such as a static RAM SRAM, a dynamic RAM DRAM, a synchronous DRAM SDRAM, a phase-change RAM PRAM, a magnetic RAM MRAM, a resistive RAM RRAM, a ferroelectric RAM FRAM, a NOR flash memory, etc.

The memory interface 150 includes a protocol for communicating with the memory device 200. For example, the memory interface 150 may include one or more of flash interfaces such as a NAND interface, a NOR interface, etc.

The error correction block 160 may detect error of data read from the memory device 200 and may correct the error.

The host interface 170 includes a protocol for exchanging data between the host Host and the memory controller 100. For example, the memory controller 100 communicates with the host Host through at least one of interface protocols, such as a universal serial bus USB protocol, a multimedia card MMC protocol, a peripheral component interconnection PCI protocol, a PCI-express PCI-E protocol, an advanced technology attachment ATA protocol, a serial-ATA protocol, a parallel-ATA protocol, a small computer small interface SCSI protocol, an enhanced small disk interface ESDI protocol, an integrated drive electronics IDE protocol, etc.

The memory controller 100 and the memory device 200 may be integrated in one memory device. In one embodiment, the memory controller 100 and the memory device 200 may be integrated in a semiconductor device to realize a memory card. For example, the memory controller 100 and the memory device 200 integrated in a semiconductor device may realize a personal computer memory card international association PCMCIA, a compact flash card CF, a smart media card SM or SMC, a memory stick, a multimedia card MMC, RS-MMC or MMCmicro, an SD card, SD, miniSD, microSD or SDHC, a universal flash storage device UFS, etc. The memory controller 100 and the memory device 200 integrated in a semiconductor device may realize a solid state drive SSD.

The memory controller 100 may include a flash translation layer (FTL) 130. The FTL 130 provides various means for controlling the memory device 200.

The memory device 200 may be a flash memory device. The flash memory device 200 has “erase before write” characteristics. In the flash memory device 200, unit of a read operation and a program operation is different from that of an erase operation. The read operation and the program operation of the flash memory device 200 are performed in a unit of a page, and the erase operation is performed in a unit of a memory block. The memory block includes pages. The flash memory device 200 has limited number of the program operation and the erase operation. Time required for the erase operation, the program operation and the read operation of the flash memory device 200, respectively, differ from one another.

When the host Host accesses to the flash memory device 200, the FTL 130 provides various control means based on the characteristics of the flash memory device 200 as described above. For example, the FTL 130 is configured to convert a logical address received from the host Host to a physical address of the flash memory device 200. The FTL 130 stores mapping information between the logical address and the physical address as a table. The FTL 130 is configured to equalize the number of the program operation of memory blocks and the number of the erase operation of the memory is blocks in the flash memory device 200. For example, the FTL 130 may be used for wear leveling. The FTL 130 may minimize the number of the erase operation of the flash memory device 200. For example, the flash memory device 200 provides a control means such as merge, garbage collection, etc.

A power-on read operation is performed when a power of the semiconductor device 10 is turned on. In this time, the memory controller 100 may load the FTL 130 stored in the flash memory device 200. The FTL 130 may be stored in a non-volatile RAM of the memory controller 100. The processor 120 may drive the FTL 130 stored in the non-volatile RAM.

The flash memory device 200 may include a memory array 210 and peripheral circuits 220 to 250.

The memory array 210 includes memory blocks. Each of the memory blocks in a NAND flash memory includes memory strings coupled between bit lines and a common source line. Respective memory string may include a drain select transistor coupled to one of the bit lines, a source select transistor coupled to the common source line, and memory cells coupled in series between the drain select transistor and the source select transistor. The memory cells in the memory strings are coupled to word lines. The memory cells coupled to one of the word lines form one physical page.

The peripheral circuits 220 to 250 store data in memory cells coupled to the even word lines or odd word lines of the memory block. In the event that a memory block, where every data stored in the memory cells coupled to the even/odd word lines is invalidated, is detected, the peripheral circuits 220 to 250 store data in memory cells coupled to the odd/even word lines of the detected memory block. The peripheral circuit 220 to 250 may include a control circuit 220, a voltage supply circuit 230, a read/write circuit 240 and an input/output circuit 250.

The control circuit 220 controls the voltage supply circuit 230, the read/write circuit 240 and the input/output circuit 250 when the program operation, the read operation and the erase operation of the memory cells are performed.

The voltage supply circuit 230 outputs operation voltages needed for the program operation, the read operation or the erase operation to the memory block.

The read/write circuit 240 senses data stored in the memory cells through bit lines in the read operation and latches the sensed data, or supplies selectively a program inhibition voltage and a program allowable voltage to the bit lines according to data stored in the memory cells when the program operation is performed. The read/write circuit 240 may be embodied with a page buffer.

The input/output circuit 250 delivers data inputted from the memory controller 100 to the read/write circuit 240, or outputs data read from the memory cells to the memory controller 100.

The program operation to a selected memory block of the flash memory device 200 is usually performed in sequence from a first word line to a final word line. In this case, interference between adjacent word lines may occur due to capacitive coupling effect when the program operation of a selected word line is performed, and thus threshold voltage of programmed memory cells of adjacent word line is affected. The interference may become worse as integrity of the memory device increases and interval between the word lines becomes narrower. Moreover, the interference reduces sensing margin for reading data of 2 bits or more in one memory cell due to narrower interval between threshold voltage distributions. As a result, electrical characteristics and reliability of the operation of the memory device is deteriorated.

According to exemplary embodiments of the present invention, the memory controller 100 changes a physical address to a logical address, to store data in memory cells coupled to a first group selected from even word lines and odd word lines of a memory block selected from memory blocks in the memory device 200, and outputs the logical address to the memory device 200. The memory device 200 stores the data in the memory cells coupled to the first group in response to the logical address of the memory controller 100. Each word line of a second group selected from odd word lines and even word lines locates between the word lines of the first group. The word lines of the second group function as shielding lines protecting the word lines of the first group from the interference. The interference affecting the word lines of the second group when the memory cells coupled to the first group are programmed may not be a concern because data is not stored in memory cells coupled to the second group.

Accordingly, the data may be secured in the memory cells from interference. Storing data in the memory cells coupled to the second group is described below.

The NAND flash memory does not provide an overwrite operation unlike a hard disk. Accordingly, the NAND flash memory writes usually updated data in an empty space when the data is updated. The NAND flash memory invalidates data written previously. The memory controller 100 may change the physical address into the logical address to output the logical address to the memory device 200, so that data is stored in the memory cells coupled to the second group in the event that every data stored in the memory cells coupled to the first group is invalidated.

Storing data in the memory cells coupled to the second group may allow use of full storage capacity of the memory device 200. Also as described above, the interference affecting the word lines of the first group when the memory cells coupled to the second group are programmed may not be a concern because data is invalidated in memory cells coupled to the first group.

The FTL 130 provides garbage collection function as well as the mapping function for mapping between the physical address and the logical address. With the mapping function, the FTL 130 writes data, which a file system requests to overwrite, in an empty space and invalidates existing data to be overwritten. The mapping function reduces operations of deletion and copying to be performed. However, invalidated pages occupy memory space, and a space that the invalidated pages occupy may not be used. It is necessary to delete the invalidated data to use again the space occupied by the invalidated data. With the garbage collection function, the FTL 130 makes the space occupied by the invalidated data available. With the garbage collection function, the FTL 130 copies valid pages of a memory block to empty space and deletes data in the memory block. As a result, every page in the memory block becomes empty and available to be written.

A log buffer-based FTL is well known in the art. The log buffer-based FTL divides blocks of the flash memory into a memory block and a log memory block. The data memory block is used as data storage space, and the log memory block is used as a temporal space for storing data to be written. In the event that an overwrite command is input, corresponding data is temporarily written in the log memory block. The log buffer-based FTL may prevent further operation of deletion operation and the write operation to be performed by writing temporarily in the log memory block. However, in the event that the log memory block is full, the FTL empties data out of pages in the log memory block through the garbage collection function.

Under the condition that data is stored in the memory cells coupled to the first group, the memory controller 100 may control the memory device 200 to perform the garbage collection when there is no memory block, where every data stored in the memory cells coupled to the first group is invalidated. Further, the memory controller 100 may control the memory device 200, to perform the garbage collection after data is stored in every memory cell of preset memory blocks, e.g. log memory blocks. Here, the memory device 200 may perform the garbage collection for a memory block including most number of memory cells where stored data is invalidated. The memory controller 100 may change the physical address to a logical address of data shifted by the garbage collection.

Hereinafter, various embodiments of the above data inputting method and the garbage collection will be described in detail.

Respective memory blocks include even word lines and odd word lines disposed respectively between the even word lines. It is assumed that data is stored in the memory cells coupled to the odd word lines after data is stored in every memory cell coupled to even word lines. Order of data storage may vary according to a memory design. For example, data may be stored in the memory cells coupled to the even word lines after the data is stored in every memory cell coupled to odd word lines.

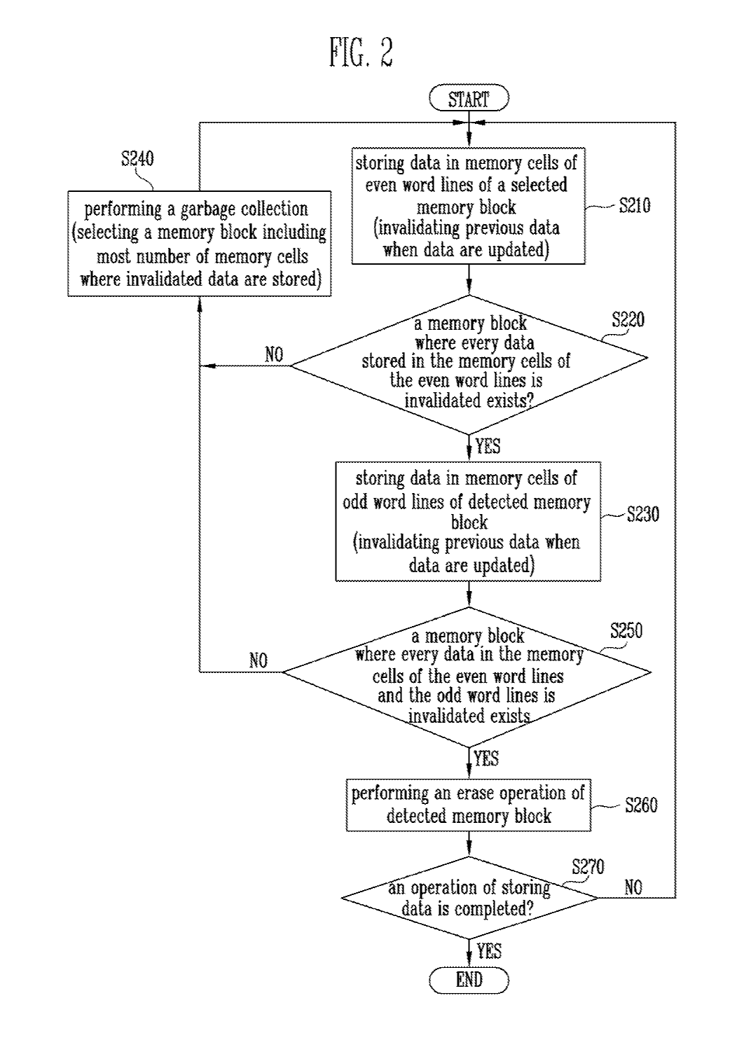

FIG. 2 illustrates a flowchart of operation of a semiconductor device according to one embodiment of the present invention.

Referring to FIG. 2, in step S210 data is stored in memory cells coupled to the even/odd word lines of a memory block selected from the memory blocks. Stored data is invalidated when data is updated. Hereinafter, for the convenience of description, it is assumed that data is stored in memory cells coupled to the even word lines, and then in memory cells coupled to the odd word lines when every data stored in the memory cells coupled to the even word lines is invalidated. On the other hand, reverse case is possible. A word line, whose status may vary according to storage status of memory cells coupled thereto, may be referred to as one of a free word line coupled to empty memory cells, a valid word line coupled to memory cells where stored data is not invalidated, and an invalid word line coupled to memory cells where stored data is invalidated.

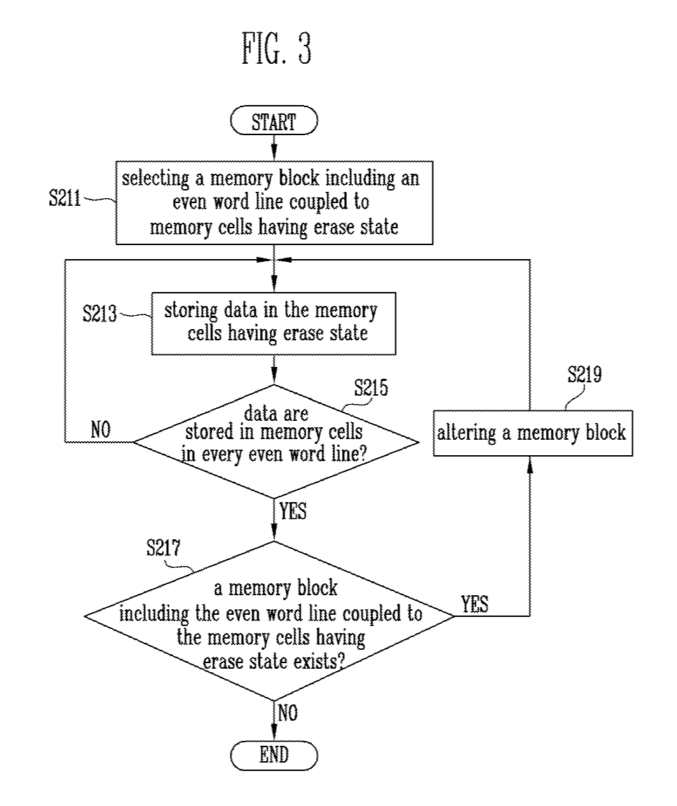

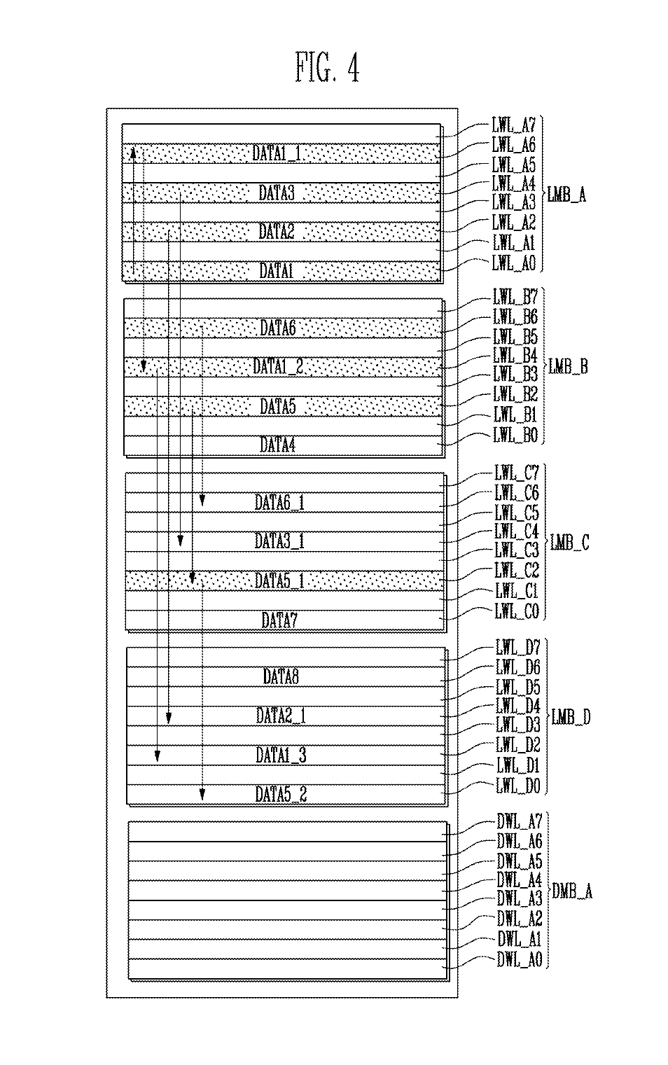

FIG. 3 illustrates a flowchart of detailed process of step S210 in FIG. 2. FIG. 4 illustrates a memory device showing an is operation of step S210 in FIG. 2 according to an embodiment of the present invention.

Referring to FIGS. 3 and 4, in step S211 a memory block, e.g. LMB_A including an even word line coupled to erased memory cells in the memory device 200 is selected according to control of the memory controller 100. A memory block LMB_A including the free word line of the even word lines is selected. That is, after completion of program operation to a part of even word lines, next program operation is performed to the rest of the even word lines or free word lines in the selected memory block LMB_A.

As an embodiment of the present invention, the selected memory block LMB_A may be the log memory block.

In step S213, data is stored in the erased memory cells in the selected memory block LMB_A. That is, data DATA1, DATA2, DATA3 and DATA1_{—}1 are sequentially stored in memory cells coupled to free word lines or even word lines LWL_A0, LWL_A2, LWL_A4 and LWL_A6.

Here, in the event that the updated data DATA1_{—}1 is stored in the memory cells coupled to the even word line LWL_A6, the previous data of the updated data DATA1_{—}1 stored in the memory cells coupled to the even word line LWL_A0 is invalidated.

In step S215, it is detected whether or not data is stored in the memory cells coupled to every even word line LWL_A0, LWL_A2, LWL_A4 and LWL_A6. Step S213 is repeated until data is stored in the memory cells coupled to every even word line LWL_A0, LWL_A2 LWL_A4 and LWL_A6. In the event that data is stored in the memory cells coupled to every even word line LWL_A0, LWL_A2, LWL_A4 and LWL_A6, it is detected whether or not there is another memory block with the free word line or the even word line coupled to erased memory cells in step S217.

In the event that there is another memory block, e.g. LMB_B with the free word line or the even word line coupled to erased memory cells, the selected memory block is altered from the memory block LMB_A to the memory block LMB_B in step S219, and then the process goes back to step S213. Steps S213 to S217 are repeated until there is no other memory block with the free word line or the even word line coupled to erased memory cells.

When there is no other memory block with the free word line or the even word line coupled to erased memory cells or when step S210 is completed, data DATA4, DATA5, DATA1_{—}2 and DATA6 are stored in even word lines LWL_B0, LWL_B2, LWL_B4 and LWL_B6 of the memory block LMB_B, data DATA7, DATA5_{—}1, DATA3_{—}1 and DATA6_{—}1 are stored in even word lines LWL_C0, LWL_C2, LWL_C4 and LWL_C6 of a memory block LMB_C, and data DATA5_{—}2, DATA1_{—}3, DATA2_{—}1 and DATA8 are stored in even word lines LWL_D0, LWL_D2, LWL_D4 and LWL_D6 of a memory block LMB_D. Here, even word lines LWL_A0, LWL_A6, LWL_B4, LWL_A2, LWL_A4, LWL_B2, LWL_C2 and LWL_B6 coupled to the memory cells where previously stored data DATA1, DATA1_{—}1, DATA1_{—}2, DATA2, DATA3, DATA5, DATA5_{—}1 and DATA6 become invalid word lines according as updated data DATA1_{—}3, DATA2_{—}1, DATA3_{—}1, DATA5_{—}2 and DATA6_{—}1 are stored in even word lines LWL_D2, LWL_D4, LWL_C4, LWL_D0 and LWL_C6.

As a result of step S210, all of even word lines LWL_A0, LWL_A2, LWL_A4 and LWL_A6 of the memory block LMB_A are invalid according to the data update.

Referring back to FIG. 2, in step S220, it is detected whether or not there is a memory block, where every data stored in the memory cells coupled to the even word lines is invalidated.

Since there is a memory block (LMB_A in FIG. 4), where every data stored in the memory cells coupled to the even word lines is invalidated, in step S230, data is stored in odd word lines LWL_A1, LWL_A3, LWL_A5 and LWL_A7 of the memory block LMB_A detected in step S220. Detailed operation is as follows.

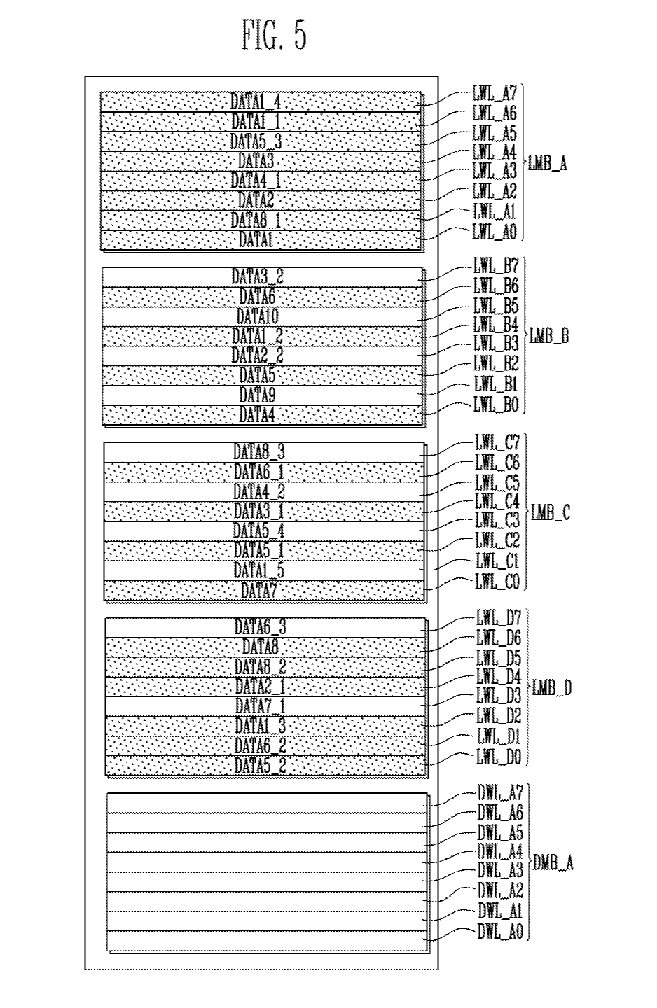

FIG. 5 illustrates memory devices showing an operation of step S230 in FIG. 2 according to one embodiment of the present invention. The detailed operation of step S230 may be substantially the same as that of step S210, namely steps S211 to S219 except that the detailed operation of step S230 is performed to odd word lines.

Referring to FIG. 5, in step S230 data is stored in erased memory cells coupled to the odd word lines LWL_A1, LWL_A3, LWL_A5 and LWL_A7 in the memory block LMB_A, where every data stored in the memory cells coupled to the even word lines is invalidated. That is, data DATA8_{—}1, DATA4_{—}1, DATA5_{—}3 and DATA1_{—}4 are sequentially stored in the memory cells coupled to the odd word lines LWL_A1, LWL_A3, LWL_A5 and LWL_A7 in the memory block LMB_A.

Here, in the event that the updated data DATA8_{—}1, DATA4_{—}1, DATA5_{—}3 and DATA1_{—}4 are stored in the memory cells coupled to the odd word lines LWL_A1, LWL_A3, LWL_A5 and LWL_A7, even word lines LWL_D6, LWL_B0, LWL_D0 and LWL_D2 of memory cells storing previous data of the updated data DATA8_{—}1, DATA4_{—}1, DATA5_{—}3 and DATA1_{—}4, namely DATA8, DATA4, DATA5_{—}2 and DATA1_{—}3 become invalid.

As a result, all of even word lines LWL_B0, LWL_B2, LWL_B4 and LWL_B6 of the memory block LWL_B are invalid according to the data update, and data DATA9, DATA2_{—}2 and DATA10, DATA3_{—}2 are sequentially stored in memory cells coupled to the odd word lines LWL_B1, LWL_B3, LWL_B5 and LWL_B7 of the memory block LWL_B.

In the event that the updated data DATA2_{—}2 and DATA3_{—}2 are stored in memory cells coupled to the odd word lines is LWL_B3 and LWL_B7, even word lines LWL_D4 and LWL_C4 of memory cells storing previous data of the updated data DATA2_{—}2 and DATA3_{—}2, namely DATA2_{—}1 and DATA3_{—}1 become invalid.

As a result, all of even word lines LWL_D0, LWL_D2, LWL_D4 and LWL_D6 of the memory block LWL_D are invalid according to the data update, and data DATA6_{—}2, DATA7_{—}1, DATA8_{—}2 and DATA6_{—}3 are sequentially stored in memory cells coupled to the odd word lines LWL_D1, LWL_D3, LWL_D5 and LWL_D7 of the memory block LWL_D.

In the event that the updated data DATA6_{—}2, DATA7_{—}1, DATA8_{—}2 and DATA6_{—}3 are stored in memory cells coupled to the odd word lines LWL_D1, LWL_D3, LWL_D5 and LWL_D7, word lines LWL_C6, LWL_C0, LWL_A1, LWL_D1 of memory cells storing previous data of the updated data DATA6_{—}2, DATA7_{—}1, DATA8_{—}2 and DATA6_{—}3, namely DATA6_{—}1, DATA7, DATA8_{—}1 and DATA6_{—}2 become invalid.

As a result, all of even word lines LWL_C0, LWL_C2, LWL_C4, LWL_C6 of the memory block LWL_C are invalid according to the data update, and data DATA1_{—}5, DATA5_{—}4, DATA4_{—}2 and DATA8_{—}3 are sequentially stored in memory cells coupled to the odd word lines LWL_C1, LWL_C3, LWL_C5 and LWL_C7 of the memory block LWL_C.

In the event that the updated data DATA1_{—}5, DATA5_{—}4 DATA4_{—}2 and DATA8_{—}3 are stored in the memory cells coupled to the odd word lines LWL_C1, LWL_C3, LWL_C5, LWL_C7, word lines LWL_A7, LWL_A5, LWL_A3 and LWL_D5 of memory cells storing previous data of the updated data DATA1_{—}5, DATA5_{—}4, DATA4_{—}2 and DATA8_{—}3, namely DATA1_{—}4, DATA5_{—}3, DATA4_{—}1 and DATA8_{—}2 become invalid.

As a result, all of word lines LWL_A0 to LWL_A7 of the memory block LWL_A becomes invalid according to the data update.

Referring back to FIG. 2, in step S250, it is detected whether or not there is a memory block, where every data stored in the memory cells coupled to the even and odd word lines is invalidated. Since there is a memory block (LMB_A in FIG. 5), where every data stored in the memory cells coupled to the even and odd word lines is invalidated, in step S260, an erase operation for the memory block LMB_A is performed.

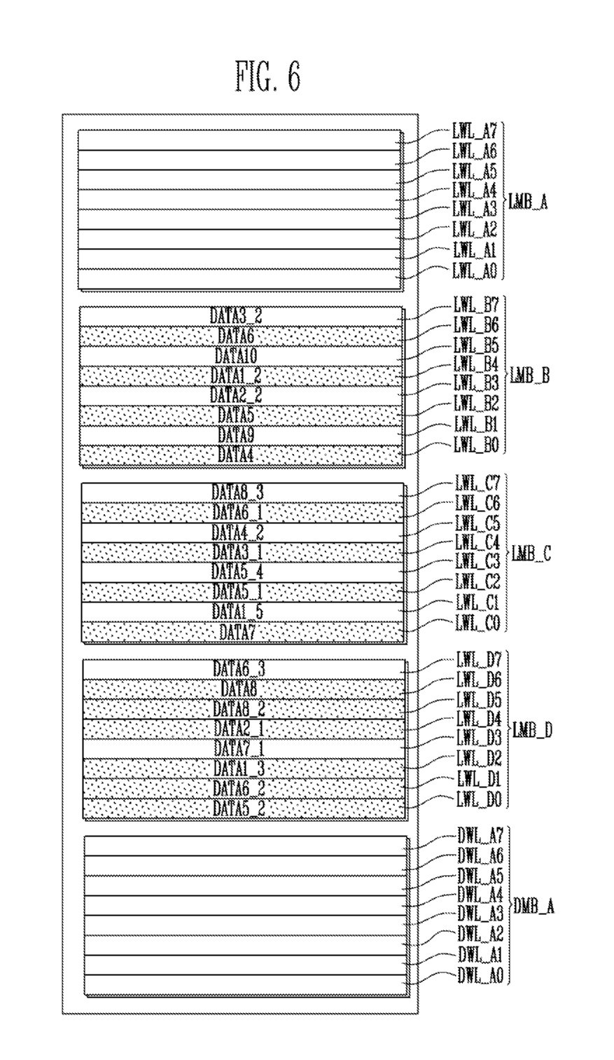

FIG. 6 illustrates memory devices showing an operation of step S260 in FIG. 2 according to one embodiment of the present invention.

Referring to FIG. 6, in step S260, the peripheral circuit performs an erase operation of the memory block LMB_A where every data stored in the memory cells coupled to the even word lines LWL_A0, LWL_A2, LWL_A4 and LWL_A6 and the odd word lines LWL_A1, LWL_A3, LWL_A5 and LWL_A7 is invalidated. As a result, the memory block LMB_A is reset to usable memory block.

Referring back to FIG. 2, as shown in step S270, steps S210 to S260 are repeated until there is no further operation of storing data.

Meanwhile, as shown in steps S220 and S250, when there is no memory block, where every data stored in the memory cells coupled to the even word lines is invalidated or where every data stored in the memory cells coupled to the even and odd word lines is invalidated, the garbage collection is performed in step S240.

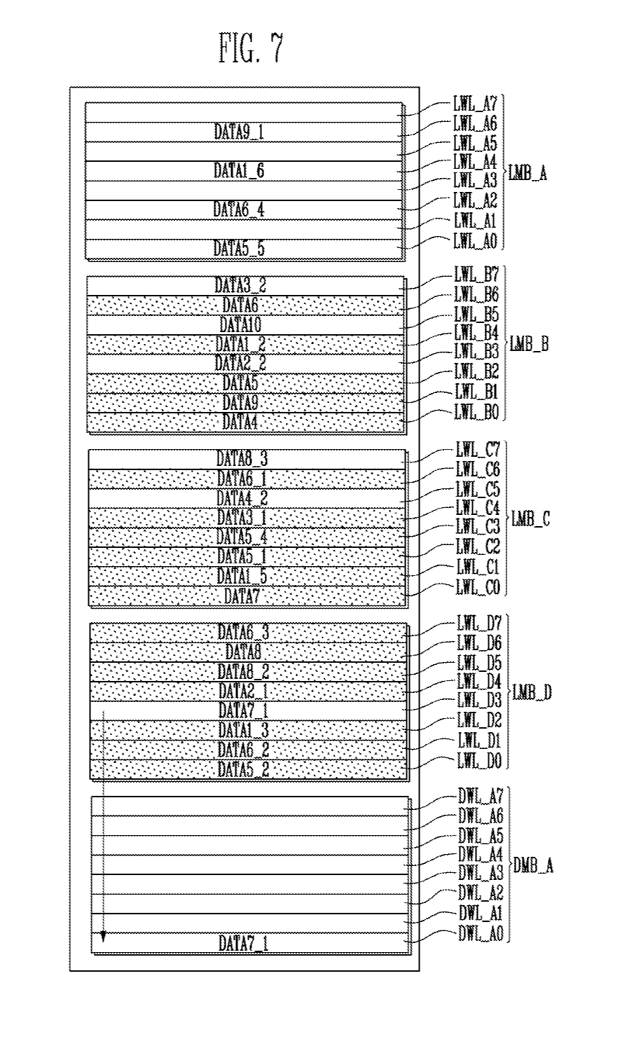

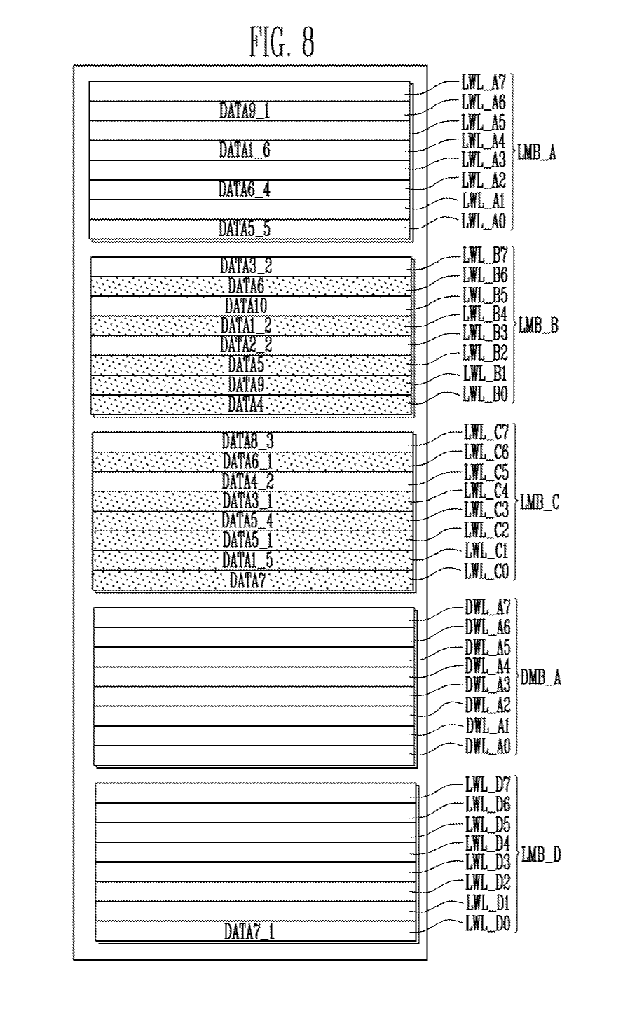

FIGS. 7 and 8 illustrate memory devices showing an operation of step S240 in FIG. 2 according to one embodiment of the present invention.

Referring to FIG. 7, the updated data DATA5_{—}5, DATA6_{—}4, DATA1_{—}6 and DATA9_{—}1 are sequentially stored in the memory cells coupled to the even word lines LWL_A0, LWL_A2, LWL_A4 and LWL_A6 of the memory block LMB_A reset to usable memory block. Word lines LWL_C3, LWL_D7, LWL_C1 and LWL_B1 storing previous data of the updated data DATA5_{—}5, DATA6_{—}4, DATA1_{—}6 and DATA9_{—}1, namely DATA5_{—}4, DATA6_{—}3, DATA1_{—}5 and DATA9 therefore become invalid.

Meanwhile, there may be no more word line coupled to available memory cell where data is to be further stored in preset memory blocks LMB_A to LMB_D. As illustrated in FIG. 7, it is impossible to store data without interference in the empty memory is cells coupled to the odd word lines LWL_A1, LWL_A3, LWL_A5 and LWL_A7 of the memory block LMB_A because valid data is stored in the memory cells coupled to the valid word lines or the even word lines LWL_A0, LWL_A2, LWL_A4 and LWL_A6 of the memory block LMB_A.

Under the situation such that a memory block, where every data stored in the memory cells coupled to the even word lines is invalidated and there is no erased memory cells coupled to the odd word lines, the memory device 200 may perform the garbage collection according to control of the memory controller 100 in the step S240. In another embodiment, the memory device 200 may perform the garbage collection according to control of the memory controller 100 after data is stored in every memory cell in the memory blocks LMB_A to LMB_D. Here, it is desirable to perform the garbage collection for the memory block, for example the memory block LMB_D including most number of memory cells where stored data is invalidated.

Referring to FIG. 7, data DATA7_{—}1 stored in a memory cell coupled to the valid word line or the even word line LWL_D3 is stored in an even word line DWL_A0 of another memory block DMB_A, which may be executed through a copyback operation.

Referring to FIG. 8, erase operation is performed for the memory block LMB_D storing the data DATA7_{—}1. An address of the is memory block LMB_D where the data DATA7_{—}1 is stored is exchanged with an address of the memory block DMB_A where the data DATA7_{—}1 is copybacked. The memory block DMB_A, whose address is previously LMB_D before address exchange, to which the erase operation is performed is reset to usable memory block.

For example as illustrated in FIG. 8, after data DATA7_{—}1 is copybacked to the data memory block DMB_A and the log memory block LMB_D is erased, the log memory block LMB_D before the copyback may be changed to a data memory block DMB_A and the data memory block DMB_A before the copyback may be changed to the log memory block LMB_D.

After the copyback and the address exchange, subsequent data storage is performed in memory cells of free word lines LWL_D2, LWL_D4 and LWL_D6 of even word lines in the memory block LMB_D.

As described above, according to the embodiment of the present invention, it is possible to prevent the interference and secure storage capacity of the memory device when data is stored in memory cells coupled to the even word lines and then data is stored in the memory cells coupled to the odd word lines disposed between the invalid even word lines. The embodiment of the present invention may be more effective with the garbage collection function.

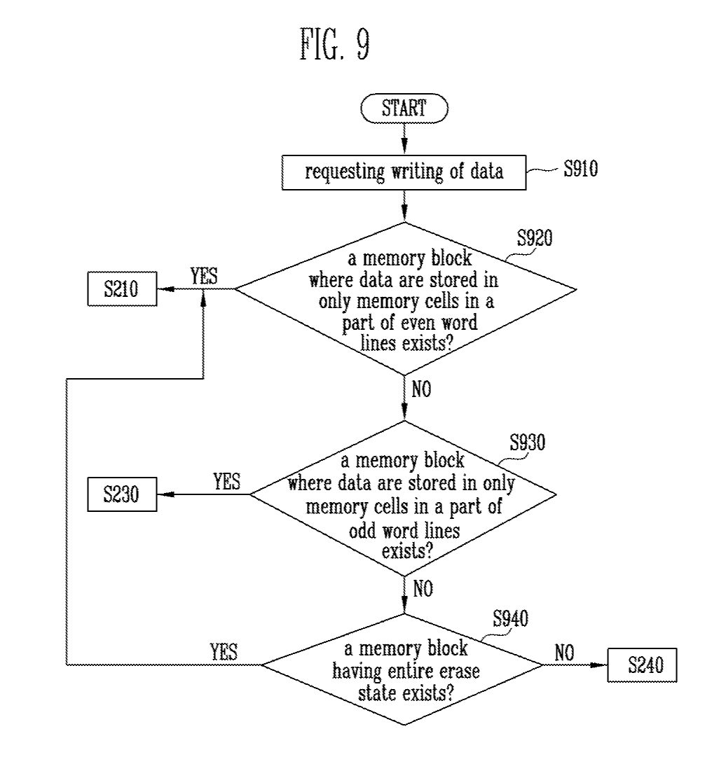

FIG. 9 illustrates a flowchart of operation of the is semiconductor device according to another embodiment of the present invention.

Referring to FIG. 9, a memory block where data is to be stored is selected through following process, when request for storing further data is inputted from the host Host in step S910 after previous operation of storing the data is completed.

In step S920, it is detected whether or not there is a memory block, where data is stored in only a part of the even word lines. In the event that such memory block is detected as a result of step S920, data is stored in memory cells coupled to the erased even word lines in substantially the same manner as step S210 in FIG. 2. That is, the data storage operation is completed after the data is stored in only memory cells of a part of the even word lines in previous data storage operation, and then data is stored in memory cells of next even word line in following data storage operation.

In the event that such memory block is not detected as a result of step S920, it is detected in step S930 whether or not there is a memory block, where data is stored in only a part of odd word lines. In the event that such memory block is detected as a result of step S930, data is stored in the memory cells coupled to the erased odd word lines in substantially the same manner as step S230 in FIG. 2. That is, the data storage operation is completed after the data is stored in only memory cells of a part of the odd word lines in previous data storage operation, and then data is stored in memory cells of next odd word line in following data storage operation.

In the event that such memory block is not detected as a result of step S930, it is detected in step S940 whether or not there is a memory block having entire erase state. In the event that such memory block having entire erase state is detected as a result of step S940, data is stored in the memory block having entire erase state in substantially the same manner as step S210 in FIG. 2.

In the event that such memory block is not detected as a result of step S940, which means that there is not a memory block capable of storing data. Hence, the garbage collection is performed to make a memory block capable of storing data in substantially the same manner as step S240 in FIG. 2. Once the process of FIG. 9 goes to any step of FIG. 2, the process follows the steps of FIG. 2.

Although various embodiments have been described for illustrative purpose, it should be understood that numerous other modifications and embodiments may be devised by those skilled in the art that will fall within the spirit and scope of the principles of this disclosure.

What is claimed is:

1. A method of operating a semiconductor device, the method comprising:
storing data in memory cells coupled to first word lines of memory blocks including the first word lines and second word lines located respectively between the first word lines;
detecting a memory block, where data stored in the memory cells of the first word lines is invalidated, from the memory blocks; and
storing data in memory cells coupled to the second word lines of the detected memory block.

2. The method of claim 1, wherein the detected memory block includes the second word lines coupled to memory cells of erase state.

3. The method of claim 1, wherein the memory block is detected after every data is stored in the memory cells of the first word lines included in the memory blocks.

4. The method of claim 1, wherein the data stored in the memory cells of the first word line or the second word line are invalidated in the event that the data stored in the memory cells of the first word line or the second word line are updated.

5. The method of claim 4, wherein the updated data is stored in memory cells of another word line in the event that the data stored in the memory cells of the first word line or the second word line are updated.

6. The method of claim 1, further comprising:
performing an erase operation of the memory block where every data stored in the memory cells of the first word lines and the second word lines is invalidated.

7. The method of claim 1, further comprising:
performing a garbage collection of a memory block including most number of memory cells where stored data is invalidated.

8. The method of claim 7, wherein the garbage collection is performed in the event that a memory block capable of storing data in the memory cells of the first word lines and a memory block capable of storing data in the memory cells of the second word lines are not detected.

9. The method of claim 1, wherein data is stored in memory cells of the other first word lines in the event that a memory block, where data is stored in only memory cells of a part of the first word lines, is detected, and
data is stored in memory cells of the other second word lines in the event that a memory block, where data is stored in only memory cells of a part of the second word lines.

10. The method of claim 1, wherein the memory block is a log memory block in a memory array including data memory blocks and the log memory blocks.

11. A semiconductor device comprising:
memory blocks, each memory block including first word lines and second word lines located respectively between the first word lines; and
a peripheral circuit configured to store data in memory cells coupled to the first word lines of the memory blocks, and store data in memory cells coupled to the second word lines of detected memory block in the event that a memory block, where every data stored in the memory cells of the first word lines is invalidated, is detected from the memory blocks.

12. The semiconductor device of claim 11, wherein the memory blocks include data memory blocks and log memory blocks, and
the peripheral circuit detects the memory block after every data is stored in the memory cells of the first word lines included in the log memory blocks.

13. The semiconductor device of claim 11, wherein the peripheral circuit invalidates the data stored in the memory cells of the first word line or the second word line in the event that the data stored in the memory cells of the first word line or the second word line are updated.

14. The semiconductor device of claim 13, wherein the peripheral circuit stores the updated data in memory cells of another word line, when the data stored in the memory cells of the first word line or the second word line are updated.

15. The semiconductor device of claim 11, wherein the peripheral circuit performs an erase operation of a memory block where every data stored in the memory cells of the first word lines and the second word lines is invalidated.

16. The semiconductor device of claim 11, wherein the peripheral circuit performs a garbage collection of a memory block including most number of memory cells where the stored data is invalidated.

17. The semiconductor device of claim 16, wherein the peripheral circuit performs the garbage collection in the event that a memory block capable of storing data in memory cells of the first word lines or the second word lines is not detected.

18. The semiconductor device of claim 18, wherein the peripheral circuit stores data in memory cells of the other first word lines in the event that a memory block, where data is stored in only memory cells of a part of the first word lines, is detected, and
stores data in memory cells of the other second word lines in the event that a memory block, where data is stored in only memory cells of a part of the second word lines, is detected.

19. A semiconductor device comprising:
a memory device configured to include memory blocks, each memory block including first word lines and second word lines located respectively between the first word lines; and
a memory controller configured to control the memory device to store data in first memory cells coupled to the first word lines of a memory block selected from the memory blocks, and change a physical address to a logical address and output the logical address to the memory device, to store data in second memory cells coupled to the second word lines in the event that the data stored in the first memory cells are invalidated.

20. The semiconductor device of claim 19, wherein the memory device performs a garbage collection of a memory block including most number of memory cells where the stored data is invalidated.
